(19) United States
(12) Patent Application Publication
(10) Pub. No.: US 2023/0054530 A1
(43) Pub. Date: Feb. 23, 2023

(54) COMMUNICATION MANAGEMENT APPARATUS AND METHOD

(71) Applicants: KABUSHIKI KAISHA TOSHIBA, Tokyo (JP); TOSHIBA DIGITAL SOLUTIONS CORPORATION, Kawasaki-shi (JP)

(72) Inventors: Atsushi KAKEMURA, Kokubunji (JP); Ryota YOSHIZAWA, Kawasaki (JP); Yutaro SAEKI, Kawasaki (JP)

(73) Assignees: KABUSHIKI KAISHA TOSHIBA, Tokyo (JP); TOSHIBA DIGITAL SOLUTIONS CORPORATION, Kawasaki-shi (JP)

(21) Appl. No.: 17/759,248

(22) PCT Filed: Jan. 22, 2021
(86) PCT No.: PCT/JP2021/002181

§ 371 Date: Jul. 21, 2022

(30) Foreign Application Priority Data
Jan. 27, 2020 (JP) 2020-010639
Jun. 30, 2020 (JP) 2020-112961

(51) Int. Cl. H04W 4/14

(52) U.S. Cl. CPC H04W 4/14

(57) ABSTRACT

A communication system includes a management apparatus and an agent apparatus. The management apparatus broadcasts the voice of an utterance of one of users of mobile communication terminals to the mobile communication terminals of the other users and to chronologically accumulate the result of utterance voice recognition of the utterance voice as a user-to-user communication history to control text delivery such that the communication history is displayed on the mobile communication terminals in synchronization. The agent apparatus produces an agent utterance text based on detection information output from a state detection device provided for a monitoring target and transmitting the agent utterance text to the management apparatus. The management apparatus broadcasts synthesized voice data of the agent utterance text to the mobile communication terminals and to chronologically accumulate the agent utterance text in the user-to-user communication history to control text delivery to the mobile communication terminals.

### TECHNICAL FIELD

Embodiments of the present invention relate to a technique for assisting in communication using voice and text (for sharing of recognition, conveyance of intention and the like).

### BACKGROUND ART

Communication by voice is performed, for example, with transceivers. A transceiver is a wireless device having both a transmission function and a reception function for radio waves and allowing a user to talk with a plurality of users (to perform unidirectional or bidirectional information transmission). The transceivers can find applications, for example, in construction sites, event venues, and facilities such as hotels and inns. The transceiver can also be used in radio-dispatched taxis, as another example.

### PRIOR ART DOCUMENT

### Patent Document

[Patent Document 1] Japanese Patent Laid-Open No. 2013-187599

### DISCLOSURE OF THE INVENTION

### Problems to be Solved by the Invention

It is an object of the present invention to provide a communication system capable of forming a communication group including an agent responsible for transmitting a state or status change to assist in information transmission among a plurality of users.

### Means for Solving the Problems

According to an embodiment, in a communication system, a plurality of users carry their respective mobile communication terminals, and the voice of an utterance of one of the users input to his mobile communication terminal is broadcast to the mobile communication terminals of the other users. The communication system includes a communication management apparatus connected to each of the mobile communication terminals through wireless communication, and an agent apparatus connected to the communication management apparatus and configured to receive detection information output from a state detection device provided for a monitoring target. The communication management apparatus includes a communication control section having a first control section configured to broadcast utterance voice data received from one of the mobile communication terminals to the other mobile communication terminals and a second control section configured to chronologically accumulate the result of utterance voice recognition from voice recognition processing on the received utterance voice data as a user-to-user communication history and to control text delivery such that the communication history is displayed on the mobile communication terminals in synchronization. The agent apparatus includes an utterance text transmission section configured to produce an agent utterance text based on the detection information and to transmit the produced agent utterance text to the communication management apparatus. The communication control section is configured to broadcast synthesized voice data of the agent utterance text produced through voice synthesis processing to the mobile communication terminals and to chronologically accumulate the received agent utterance text in the user-to-user communication history to control text delivery to the mobile communication terminals.

### BRIEF DESCRIPTION OF THE DRAWINGS

FIG. 1 A diagram showing the configuration of a network of a communication system according to Embodiment 1.

FIG. 2 A block diagram showing the configurations of a communication management apparatus, an agent apparatus, and a user terminal according to Embodiment 1.

FIG. 3 A diagram showing examples of user information and group information according to Embodiment 1.

FIG. 4 A diagram showing examples of screens displayed on user terminals according to Embodiment 1.

FIG. 5 A diagram showing an example of setting management information according to Embodiment 1.

FIG. 6 A diagram showing a flow of processing performed in the communication system according to Embodiment 1.

FIG. 7 A diagram showing a flow of processing of a first case performed in the communication system according to Embodiment 1.

FIG. 8 A diagram showing the configuration of a network of a communication system according to Embodiment 2.

FIG. 9 A block diagram showing the configurations of a communication management apparatus, an agent apparatus, and a user terminal according to Embodiment 2.

FIG. 10 A diagram showing a flow of processing of a second case performed in the communication system according to Embodiment 2.

FIG. 11 A diagram showing examples of screens displayed on user terminals according to Embodiment 2.

FIG. 12 A diagram for illustrating an example of interrupt processing to enter an individual calling mode during a group calling mode in Embodiment 3.

FIG. 13 A block diagram showing the configurations of a communication management apparatus, an agent apparatus, and a user terminal according to Embodiment 3.

FIG. 14 A diagram showing an example of specified notification setting information according to Embodiment 3.

FIG. 15 A diagram showing a flow of processing of a third case performed in a communication system according to Embodiment 3.

### MODE FOR CARRYING OUT THE INVENTION

### Embodiment 1

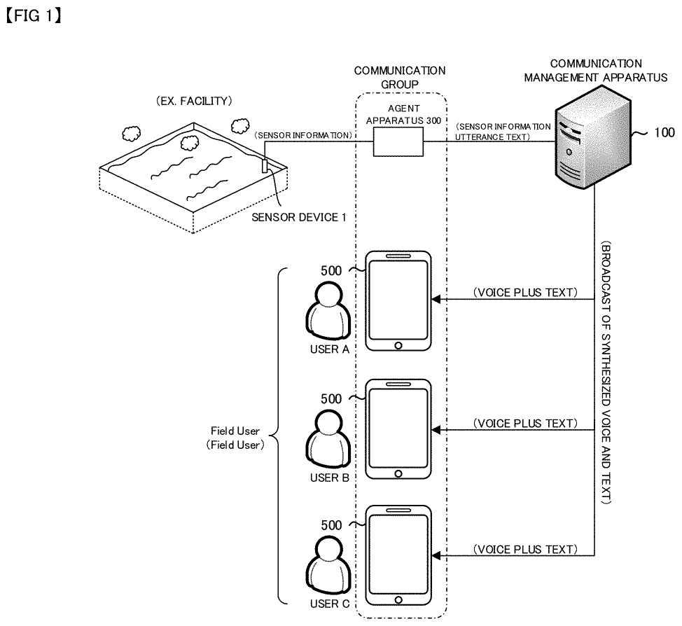

FIGS. 1 to 7 are diagrams for illustrating Embodiment 1.

FIG. 1 is a diagram showing the configuration of a network of a communication system according to Embodiment 1. The communication system provides an information transmission assistance function with the use of voice and text such that a communication management apparatus (hereinafter referred to as a management apparatus) 100 plays a central role. An aspect of using the communication system for facility management is described below, by way of example.

The management apparatus 100 is connected to user terminals (mobile communication terminals) 500 carried by users through wireless communication and broadcasts the voice of an utterance (speech) of one of the users to the user terminals 500 of the other users.

The user terminal 500 may be a multi-functional cellular phone such as a smartphone, or a portable terminal (mobile terminal) such as a Personal Digital Assistant (PDA) or a tablet terminal. The user terminal 500 has a communication function, a computing function, and an input function, and connects to the management apparatus 100 through wireless communication over the Internet Protocol (IP) network or Mobile Communication Network to perform data communication.

A communication group is set to define the range in which the voice of an utterance of one of the users can be broadcast to the user terminals 500 of the other users (or the range in which a communication history, later described, can be displayed in synchronization). Each of the user terminals 500 of the relevant users (field users) is registered in the communication group. As shown in FIG. 1, in Embodiment 1, an agent apparatus 300 receives detection information output from a state detection device (sensor device 1) provided for a monitoring target in the facility management, connects to the management apparatus 100 through wireless or wired communication, and is registered as a member (agent) of the communication group in which the users are registered.

When the monitoring target is a hot spring, the state of the hot spring is its temperature, for example. In this case, the state detection device is a measuring device such as a temperature sensor 1. The temperature sensor 1 outputs a detected temperature corresponding to the detection information to the agent apparatus 300. Upon input of the detected temperature, the agent apparatus 300 produces an agent utterance text based on the detected temperature and transmits the produced text to the management apparatus 100. Thus, the agent apparatus 300 is a device for providing an utterance (speech) function based on the detection information as a member of the communication group similar to the users carrying the user terminals 500 and is positioned as an utterance (speech) proxy on behalf of the state detection device.

The agent apparatus 300 may be a desktop computer, a tablet computer, or a laptop computer. The agent apparatus 300 has a data communication function provided through wireless or wired communication over the IP network or Mobile Communication Network and a computing function (implemented by a CPU or the like). The agent apparatus 300 may include a display (or a touch-panel display device) and character input means. The agent apparatus 300 may be a dedicated device having functions provided in Embodiment 1.

The communication system according to Embodiment 1 assists in information transmission for sharing of recognition, conveyance of intention and the like based on the premise that the plurality of users can perform hands-free interaction with each other. In addition, the communication group is formed to include the agent for transmitting a state or status change of the monitoring target in the facility management, and the utterance function of the agent can help more efficient acquisition and transmission of the information about the state or status change of the monitoring target which may conventionally be performed manually.

Equipment management in a facility is human-intensive and inevitably includes tasks of operating and controlling an equipment instrument manually. Such operation and control of the equipment instrument should be performed while continuously checking the state or status of the equipment instrument. To do this, a user should visit the equipment instrument to check its status or visit the site where an associated state detection device is installed to check detection information thereof, which necessitates a large amount of labor. In recent years, the use of IoT (Internet of Things) has attracted attention to achieve cooperation between a sensor device and the operation and control of an equipment instrument. The IoT, however, has problems in cost and other aspects, and thus the equipment management is still human-intensive.

Embodiment 1 reduces the burden on the users in manual operation and control of the equipment instrument by introducing the approach in which the sensor device or the like configured to output detection information for presenting the state or status of the equipment instrument provides the utterance function based on the detection information as a member of the user communication group. In addition, Embodiment 1 achieves a simple and low-cost system configuration in which the agent apparatus 300 configured to receive the detection information from the state detection device such as the existing sensor device can only be required to be installed in the site of the equipment management to easily participate in the user communication group.

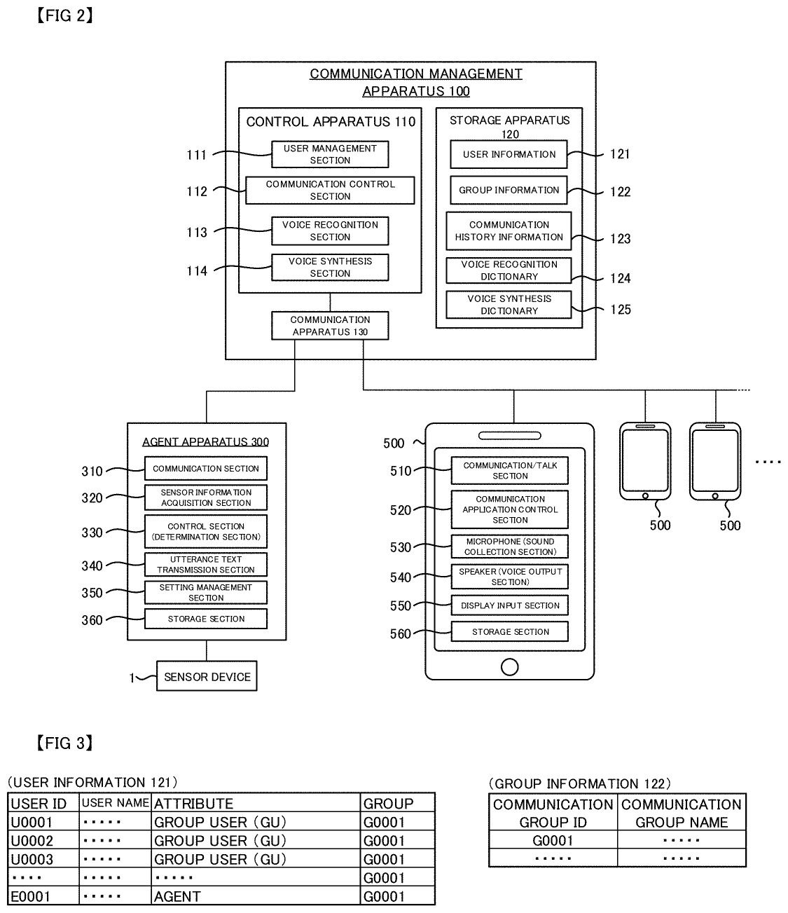

FIG. 2 is a block diagram showing the configurations of the management apparatus 100, the agent apparatus 300, and the user terminal 500.

The management apparatus 100 includes a control apparatus 110, a storage apparatus 120, and a communication apparatus 130. The communication apparatus 130 manages communication connection and controls data communication with the user terminals 500. The communication apparatus 130 controls broadcast to distribute the utterance voice and utterance text of the same content to the user terminals 500 at the same time.

The control apparatus 110 includes a user management section 111, a communication control section 112, a voice recognition section 113, and a voice synthesis section 114. The storage apparatus 120 includes user information 121, group information 122, communication history (communication log) information 123, a voice recognition dictionary 124, and a voice synthesis dictionary 125.

The agent apparatus 300 is connected in a wireless or wired manner to the state detection apparatus (sensor device 1) provided in the facility to be managed and includes a sensor information acquisition section 320 which receives detection information output from the state detection apparatus through a communication section 310. The agent apparatus 300 also includes a control section (determination section) 330, an utterance text transmission section 340, a setting management section 350, and a storage section 360.

The user terminal 500 includes a communication/talk section 510, a communication application control section 520, a microphone 530, a speaker 540, a display input section 550 such as a touch panel, and a storage section 560. The speaker 540 is actually formed of earphones or headphones (wired or wireless).

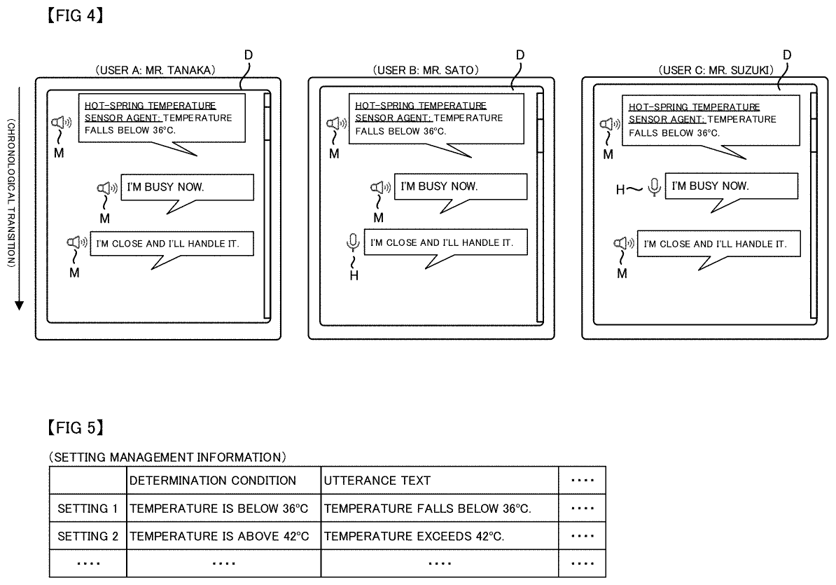

FIG. 3 is a diagram showing examples of various types of information. User information 121 is registered information about users of the communication system. The user management section 111 controls a predetermined management screen to allow setting of a user ID, user name, attribute, and group on that screen. The agent apparatus 300 is also registered as a user. Group information 122 is group identification information representing separated communication groups. The communication management apparatus 100 controls transmission/reception and broadcast of information for each of the communication groups having respective communication group IDs to prevent mixed information across different communication groups. Each of the users in the user information 121 can be associated with the communication group registered in the group information 122.

The user management section 111 in Embodiment 1 provides a function of setting a communication group including registered users to perform first control (broadcast of utterance voice data) and second control (broadcast of an agent utterance text and/or a text representing the result of recognition of user's utterance voice) and a function of registering the agent apparatus 300 in the communication group.

Depending on a specific facility in which the communication system according to Embodiment 1 is introduced, grouping can be used to perform facility management by classifying the facility into a plurality of divisions. In an example of an accommodation facility, bellpersons (porters), concierges, and housekeepers (cleaners) can be classified into different groups, and the communication environment can be established such that hotel room management is performed within each of those groups. In another viewpoint, communications may not be required for some tasks. For example, serving staff members and bellpersons (porters) do not need to directly communicate with each other, so that they can be classified into different groups. In addition, communications may not be required from geographical viewpoint. For example, when a branch office A and a branch office B are remotely located and do not need to frequently communicate with each other, they can be classified into different groups.

As a result, different types of communication groups may be set in a mixed manner, including a communication group in which an agent apparatus 300 is registered, a communication group in which no agent apparatus 300 is registered, and a communication group in which a plurality of agent apparatuses 300 are registered. When a plurality of equipment instruments to be managed exist in the facility, the agent apparatus 300 can be provided for each of the equipment instruments. When a plurality of state detection devices are installed for a single equipment instrument, the agent apparatus 300 can be provided for each of the state detection devices and registered in a single communication group.

The communication control section 112 of the management apparatus 100 functions as control sections including a first control section and a second control section. The first control section controls broadcast of utterance voice data received from one user terminal 500 to the other user terminals 500. The second control section chronologically accumulates the result of utterance voice recognition from voice recognition processing on the received utterance voice data in the user-to-user communication history 123 and controls text delivery such that the communication history 123 is displayed on the user terminals 500 in synchronization.

The function provided by the first control section is broadcast of utterance voice data. The utterance voice data includes voice data artificially created through voice synthesis processing on a text (for example, the agent utterance text) and voice data representing a user's voice. The voice synthesis section 114 synthesizes voice data corresponding to the characters of the agent utterance text with the voice synthesis dictionary 125 to create synthesized voice data. The synthesized voice data can be formed of any materials of voice data.

The function provided by the second control section is broadcast of the agent utterance text and the text representing the result of utterance voice recognition of the user's voice. In Embodiment 1, all the voices input to the user terminals 500 and reproduced on the user terminals 500 are converted into texts which in turn are accumulated chronologically in the communication history 123 and displayed on the user terminals 500 in synchronization. The voice recognition section 113 performs voice recognition processing with the voice recognition dictionary 124 to output text data as the result of utterance voice recognition. The voice recognition processing can be performed by using any of known technologies.

The agent apparatus 300 includes the utterance text transmission section 340 which produces the agent utterance text based on the detection information output from the state detection device and transmits the produced text to the management apparatus 100. The communication control section 112 of the management apparatus 100 performs the function of the first control by performing voice synthesis processing on the agent utterance text received from the utterance text transmission section 340 to produce synthesized voice data of the agent utterance text and transmitting the produced data to the user terminals 500. The communication control section 112 also performs the function of the second control by chronologically accumulating the agent utterance text received from the utterance text transmission section 340 in the user-to-user communication history 123 and controlling text delivery to the user terminals 500.

The communication history information 123 is log information including contents of speeches (utterances) of the users and agent utterance texts from the agent apparatus 300, together with time information, accumulated chronologically on a text basis. Voice data corresponding to each of the texts can be stored as a voice file in a predetermined storage region, and the location of the stored voice file is recorded in the communication history 123. The communication history information 123 is created and accumulated for each communication group.

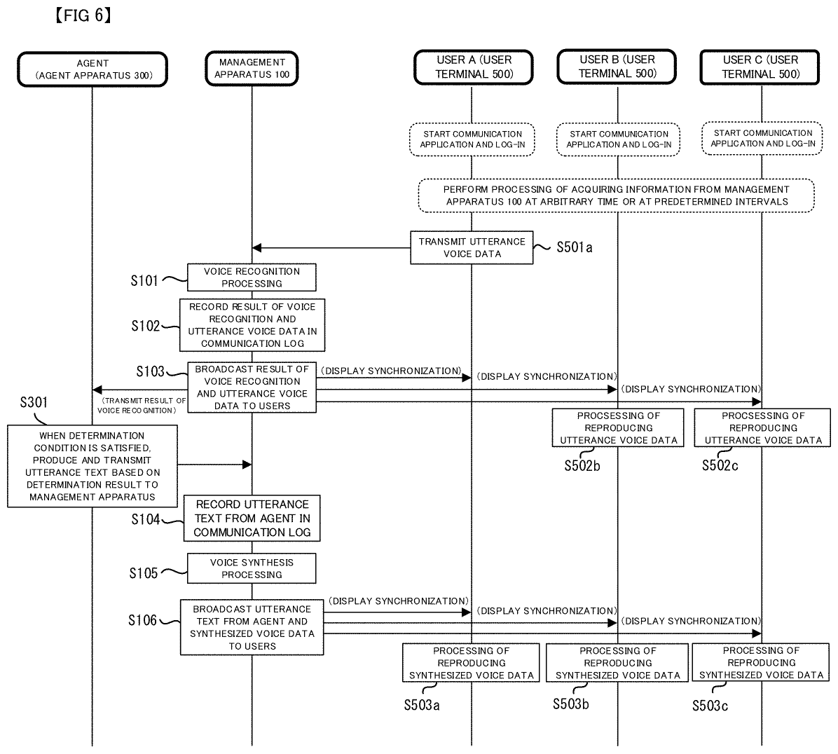

FIG. 4 is a diagram showing an example of the communication history 123 displayed on the user terminals 500. Each of the user terminals 500 receives the communication history 123 from the management apparatus 100 in real time or at a predetermined time, and the users can refer to the chronological communication log displayed in synchronization.

In a display field D, a text representing synthesized voice data may be accompanied by a voice mark M, and a speaker's own utterance text may be accompanied by a microphone mark H.

As in the example of FIG. 4, each user terminal 500 chronologically displays the utterance content of the user of that terminal 500 and the utterance contents of the other users as well as the utterance content of the agent apparatus 300 in the display field D to share the communication history 123 accumulated in the management apparatus 100 as log information.

FIG. 5 is a diagram showing an example of setting management information for use in the agent apparatus 300. The setting management information includes registered conditions under which the agent apparatus 300 performs the utterance function and the associated registered utterance text contents. The control apparatus 330 functions as a determination section for determining whether or not detection information satisfies any of the determination conditions set in the setting management information.

In the example of FIG. 5, “Setting 1” specifies a condition that the temperature is below 36° C. and an agent utterance text “Temperature falls below 36° C.” “Setting 2” specifies a condition that the temperature is above 42° C. and an agent utterance text “Temperature exceeds 42° C.” The control section 330 matches detection information acquired by the sensor information acquisition section 320 at certain time intervals with each of the determination conditions specified in the setting management information to determine whether or not any of the determination conditions is satisfied.

When the control section 330 determines that any of the determination conditions is satisfied, the utterance text transmission section 340 extracts the utterance text associated with that condition from the setting management information to produce and transmit agent utterance text data to the management apparatus 100.

The setting management information can be input through a management information registration screen provided in the agent apparatus 300. Alternatively, another computer apparatus can produce a file of setting management information including recorded pairs of different determination conditions and utterance texts, and the file can be stored in the agent apparatus 300.

FIG. 6 is a diagram showing a flow of processing performed in the communication system according to Embodiment 1.

Each of the users starts the communication application control section 520 on his user terminal 500, and the communication application control section 520 performs processing for connection to the management apparatus 100. Each user enters his user ID and password on a predetermined log-in screen to login to the management apparatus 100. The log-in authentication processing is performed by the user management section 111. After the log-in, each user terminal 500 performs processing of acquiring information from the management apparatus 100 at an arbitrary time or at predetermined time intervals.

When a user A speaks, the communication application control section 520 collects the voice of that utterance and transmits the utterance voice data to the management apparatus 100 (S501a). The voice recognition section 113 of the management apparatus 100 performs voice recognition processing on the received utterance voice data (S101) and outputs the result of voice recognition of the utterance content. The communication control section 112 stores the result of voice recognition in the communication history 123 and stores the utterance voice data in the storage apparatus 120 (S102).

The communication control section 112 broadcasts the utterance voice data of the user A to the user terminals 500 of the users other than the user A who spoke. The communication control section 112 also transmits the utterance content (in text form) of the user A stored in the communication history 123 to all the user terminals 500 within the communication group including the user terminal 500 of the user A for display synchronization (S103).

The communication application control sections 520 of the user terminals 500 other than the user terminal 500 of the user A perform automatic reproduction processing on the received utterance voice data to output the reproduced utterance voice (S502b, S502c), and displays the utterance content of text form corresponding to the output reproduced utterance voice in the display field D.

Then, the agent apparatus 300 monitors detection information output from the state detection device, and when the detection information satisfies any of the determination conditions, the utterance text transmission section 340 produces an agent utterance text based on the determination result and transmits the produced text to the management apparatus 100 (S301).

The agent utterance text may or may not include the detection information such as a sensor value. In other words, the agent utterance text is only required to indicate any of the determination conditions being satisfied. For example, the agent utterance text may be an utterance text which includes no sensor value such as “Temperature is getting lower” or “Temperature is too high.” Alternatively, the agent utterance text may be produced to include a sensor value, for example “Temperature falls below 36° C. Current temperature is 35.1° C.” Including the measured value can notify the user whether any emergency response is required or some time is left until a response should be made.

The communication control section 112 of the management apparatus 100 stores the received agent utterance text in the communication history 123 (S104). The voice synthesis section 114 produces synthesized voice corresponding to the agent utterance text (S105) and stores the produced synthesized voice in the storage apparatus 120.

The communication control section 112 broadcasts the utterance voice data from the agent apparatus 300 to all the user terminals 500 registered in the communication group. The communication control section 112 transmits the agent utterance text stored in the communication history 123 to the user terminals 500 within the communication group for display synchronization (S106).

The communication application control sections 520 of the user terminals 500 perform automatic reproduction processing on the received utterance voice data of the agent to output the reproduced utterance voice (S503a, S503b, S503c), and displays the agent utterance content of text form corresponding to the utterance voice in the display field D.

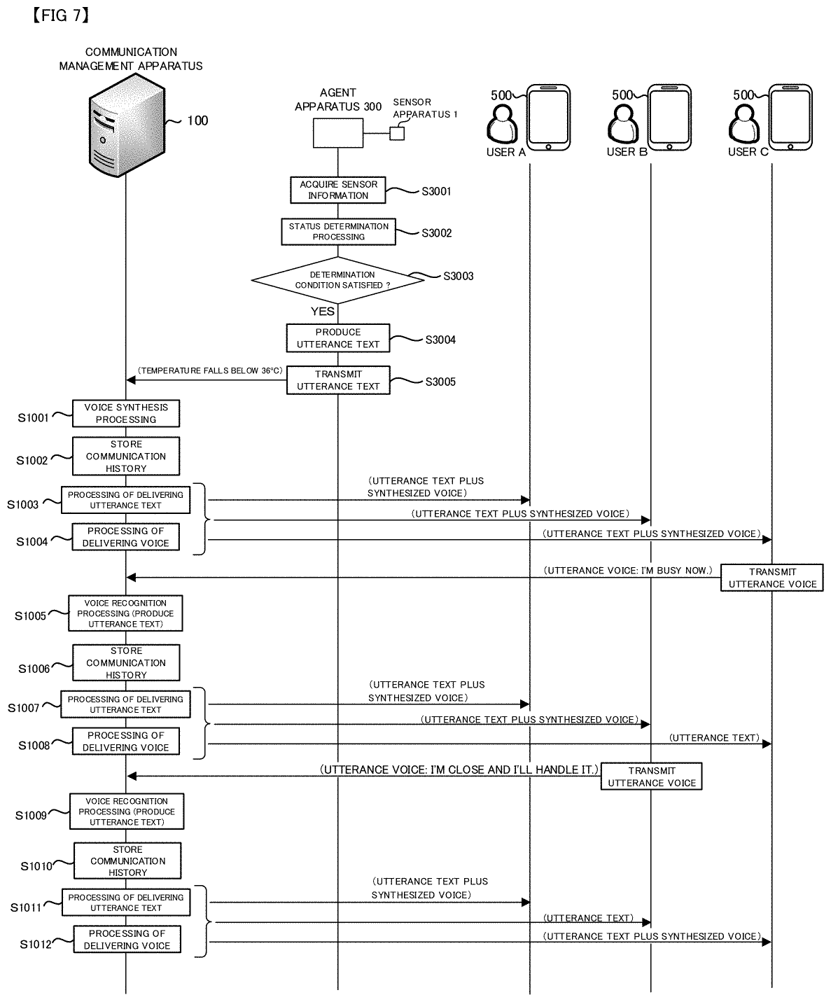

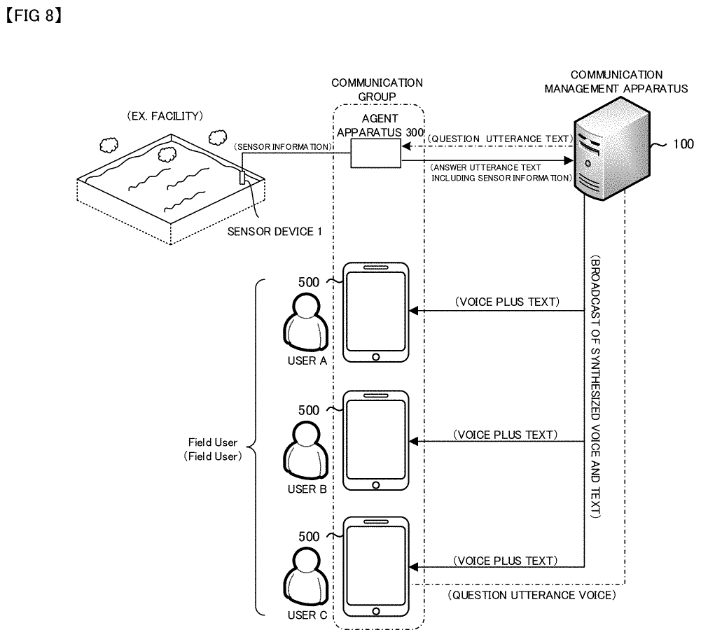

FIG. 7 is a diagram showing a flow of processing of a first case in which the communication system according to Embodiment 1 is used.

As shown in FIG. 7, the sensor information acquisition section 320 of the agent apparatus 300 acquires temperature information of the hot spring output from the state detection device (sensor device 1) at an arbitrary time or predetermined time intervals (S3001). Each time the hot spring information is acquired, the control section 330 determines whether or not the temperature of the hot spring satisfies any of the determination conditions registered in the setting management information (S3002).

When the temperature of the hot spring satisfies any of the determination conditions (YES at S3003), the utterance text transmission section 340 extracts the utterance text associated with that condition set in the setting management information to produce, for example, agent utterance text data “Temperature falls below 36° C.” (S3004). The utterance text transmission section 340 transmits the produced agent utterance text to the management apparatus 100 (S3005).

The voice synthesis section 114 of the management apparatus 100 produces synthesized voice data of the received agent utterance text (S1001). The communication control section 112 of the management apparatus 100 chronologically stores the agent utterance text received from the agent apparatus 300 in the user-to-user communication history 123 (S1002).

The communication control section 112 transmits the agent utterance text of text form to the user terminals 500 for display synchronization (S1003) and broadcasts the synthesized voice data of the agent utterance content to the user terminals 500 (S1004).

The communication application control section 520 of each of the user terminals 500 displays the agent utterance content of text form in the display fields D and performs automatic reproduction processing on the synthesized voice data to output the reproduced voice. In the display field D of each of the user terminals 500, the same agent utterance content is displayed in synchronization, and the agent utterance content “Temperature falls below 36° C.” is audibly output.

When the user C hears the agent utterance content and says “I'm busy now,” the communication application control section 520 collects the voice of that utterance and transmits the utterance voice data to the management apparatus 100. The voice recognition section 113 of the management apparatus 100 performs voice recognition processing on the received utterance voice data (1005) and outputs the result of voice recognition of the utterance content. The communication control section 112 stores the result of voice recognition in the communication history 123 and stores the utterance voice data in the storage apparatus 120 (S1006).

The communication control section 112 broadcasts the utterance voice data of the user C to the user terminals 500 of the users other than the user C who spoke (1008). The communication control section 112 transmits the utterance content “I'm busy now” of the user C stored in the communication history 123 to all the user terminals 500 within the communication group including the terminal 500 of the user C for display synchronization (S1007).

The communication application control section 520 of each of the user terminals 500 performs automatic reproduction processing on the received utterance voice data to output the reproduced utterance voice “I'm busy now” and displays the utterance content “I'm busy now” in text form corresponding to the output reproduced utterance voice in the display field D. It should be noted that the management apparatus 100 performs control such that the utterance voice data of the user C is not transmitted to his own user terminal 500.

When the user B hears the utterance of the user C and says “I'm close and I'll handle it,” the communication application control section 520 collects the voice of that utterance and transmits the utterance voice data to the management apparatus 100. The voice recognition section 113 of the management apparatus 100 performs voice recognition processing on the received utterance voice data (1009) and outputs the result of voice recognition of the utterance content. The communication control section 112 stores the result of voice recognition in the communication history 123 and stores the utterance voice data in the storage apparatus 120 (S1010).

The communication control section 112 broadcasts the utterance voice data of the user B to the user terminals 500 of the users other than the user B who spoke (1012). The communication control section 112 transmits the utterance content “I'm close and I'll handle it” of the user B stored in the communication history 123 to all the user terminals 500 within the communication group including the terminal 500 of the user B for display synchronization (S1011).

The communication application control section 520 of each of the user terminals 500 performs automatic reproduction processing on the received utterance voice data to output the reproduced utterance voice “I'm close and I'll handle it,” and displays the utterance content “I'm close and I'll handle it” in text form corresponding to the output reproduced utterance voice in the display field D. Again, the management apparatus 100 performs control such that the utterance voice data of the user B is not transmitted to his own user terminal 500.

### Embodiment 2

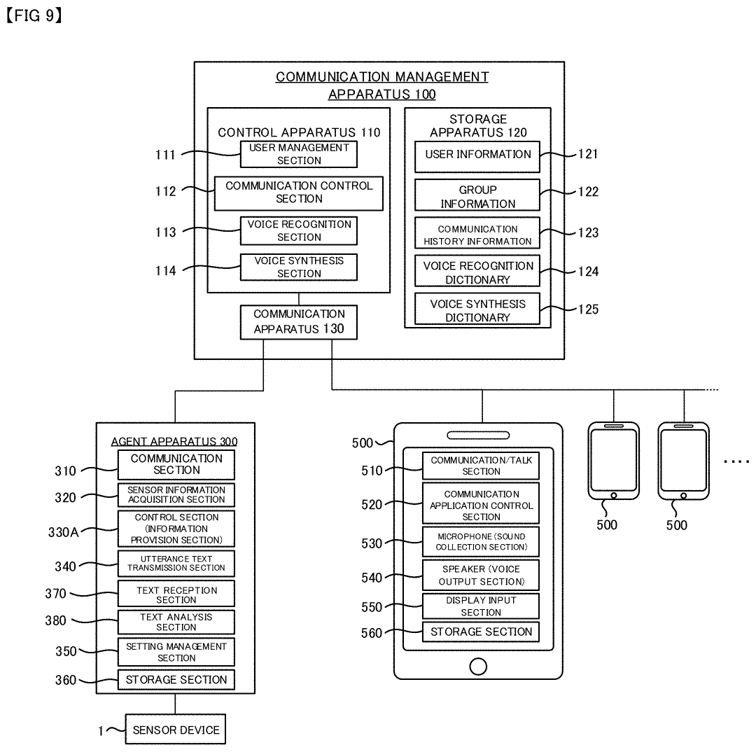

FIGS. 8 to 11 are diagrams for illustrating Embodiment 2.

FIG. 8 is a diagram showing the configuration of a network of a communication system according to Embodiment 2. The communication system according to Embodiment 2 differs from that according to Embodiment 1 in that it provides an agent function in response to a question from a user speaking on the user terminal 500. It should be noted that the same elements as those in Embodiment 1 are designated with the same reference numerals and their description is omitted.

FIG. 9 is a block diagram showing the configurations of the communication management apparatus 100, the agent apparatus 300, and the user terminal 500 in Embodiment 2. FIG. 9 differs from FIG. 2 in Embodiment 1 in that the configuration of the agent apparatus 300 is partially modified by added sections such that the agent apparatus 300 can produce, in response to a user speaking on the user terminal 500 as a trigger, an agent utterance text based on detection information and transmit the produced agent utterance text to the management apparatus 100.

More specifically, the communication control section 111 of the management apparatus 100 has a function of transmitting the result of voice recognition of an utterance voice received from one of the user terminals 500 to the agent apparatus 300. The agent apparatus 300 includes a text reception section 370 for receiving the result of voice recognition of the user's utterance voice, a text analysis section 380 for analyzing the result of voice recognition of text form, and a control section (information provision section) 330A for determining whether or not an agent utterance text should be provided based on the result of analysis in the text analysis section 380. The utterance text transmission section 340 produces an agent utterance text based on the result of determination in the control section 330A and transmits the produced agent utterance text to the management apparatus 100.

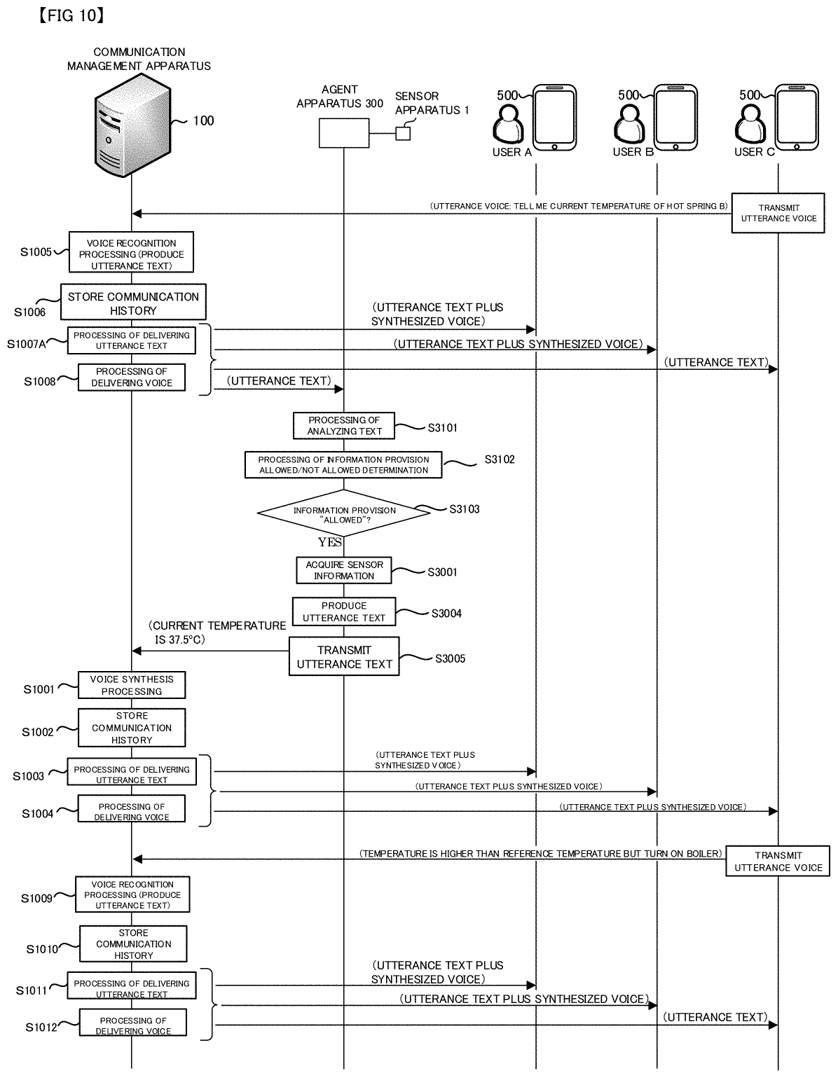

FIG. 10 is a diagram showing a flow of processing of a second case performed in the communication system according to Embodiment 2.

As shown in FIG. 10, when the user C says “Tell me the current temperature of hot spring B,” the communication application control section 520 collects the voice of that utterance and transmits the utterance voice data to the management apparatus 100. The voice recognition section 113 of the management apparatus 100 performs voice recognition processing on the received utterance voice data (1005) and outputs the result of voice recognition of the voice content. The communication control section 112 stores the result of voice recognition in the communication history 123 and stores the utterance voice data in the storage apparatus 120 (S1006).

The communication control section 112 broadcasts the utterance voice data of the user C to the user terminals 500 of the users other than the user C who spoke (1008). In addition, the communication control section 112 transmits the utterance content “Tell me the current temperature of hot spring B” of the user C stored in the communication history 123 to the user terminals 500 within the communication group including the user terminal 500 of the user C for display synchronization, and transmits the utterance content “Tell me the current temperature of hot spring B” in text form to the agent apparatus 300 (S1007A).

The agent apparatus 300 receives the utterance text “Tell me the current temperature of hot spring B” in the text reception section 370. The received utterance text is analyzed by the text analysis section 380. For example, the text analysis section 380 performs well-known morphological analysis to extract keywords (S3101) such as “hot spring B,” “temperature,” and “tell me”.

The control section (information provision section) 330A of the agent apparatus 300 uses the keywords resulting from the analysis in the text analysis section 380 to perform processing of information provision determination (3102). For example, setting management information is previously registered to include the name (hot spring B) of a target managed by the agent apparatus 300, a detection attribute (temperature) detected by the state detection device connected to the agent apparatus 300, and information representing exemplary questioning phrase (“tell me,” “what is,” “how many,” and “want to know”). In Embodiment 2, the setting management information is registered in the setting management section 350 similarly to Embodiment 1.

The control section (information provision section) 330A determines whether or not the result of voice recognition of the utterance from the user C includes any of the keywords relating to questioning about the state detection device or detection information. When it is determined that any keyword is included (YES at S3103), the control section 330A acquires the detection information in the sensor information acquisition section 320 (3001). In the illustrated example, the result of voice recognition of the utterance from the user C includes “hot spring B,” the detection attribute “temperature,” and the questioning phrase “tell me,” so that the control section 330A outputs “allowed” as the result of information provision determination.

In the above description in which it is assumed that a plurality of agent apparatuses 300 are registered in the communication group, each of the agent apparatuses 300 determines whether or not a question is directed to that agent apparatus 300 based on whether or not the question includes the name of a target managed by the agent apparatus 300. When only one agent apparatus 300 is included in the communication group, however, the agent apparatus 300 can acquire detection information from the state detection device in response to a user saying “Tell me the temperature,” for example. In addition, the name of a state detection device (temperature sensor) can be registered as information provision determining information, and in response to a question from the user C saying “Tell me the value of the temperature sensor,” the agent apparatus 300 can provide the utterance function based on the detection information.

When the result of the determination in the control section 330A is “allowed,” the sensor information acquisition section 320 of the agent apparatus 300 acquires hot-spring temperature information output from the state detection device (sensor device 1) (S3001). The utterance text transmission section 340 extracts an appropriate utterance text set in the setting management information to produce agent utterance text data “Current temperature is 37.5° C.” (S3004). The utterance text transmission section 340 transmits the produced agent utterance text to the management apparatus 100 (S3005). The agent utterance text can be produced by replacing the part “00” of a fixed phrase “Current temperature is 00° C.” previously registered insetting management information with the detection information “37.5.”

The voice synthesis section 114 of the management section 100 produces synthesized voice data of the received agent utterance text (S1001). The communication control section 112 of the management apparatus 100 chronologically stores the agent utterance text received from the agent apparatus 300 in the user-to-user communication history 123 (S1002).

The communication control section 112 transmits the agent utterance text of text form to the user terminals 500 for display synchronization (S1003) and broadcasts the synthesized voice data of the agent utterance content to the user terminals 500 (S1004).

The communication application control section 520 of each of the user terminals 500 displays the agent utterance content of text form in the display field D and performs automatic reproduction processing on the synthesized voice data to output the reproduced voice. In the display field D of each user terminal 500, the same agent utterance content is displayed in synchronization, and the agent utterance content “Current temperature is 00° C.” is audibly output.

When the user C hears the agent utterance content and says “Temperature is higher than reference temperature but turn on boiler,” the communication application control section 520 collects the voice of that utterance and transmits the utterance voice data to the management apparatus 100. The voice recognition section 113 of the management apparatus 100 performs voice recognition processing on the received utterance voice data (1009) and outputs the result of voice recognition of the voice content. The communication control section 112 stores the result of voice recognition in the communication history 123 and stores the utterance voice data in the storage apparatus 120 (S1010).

The communication control section 112 broadcasts the utterance voice data of the user C to the user terminals 500 of the users other than the user C who spoke (1012). The communication control section 112 also transmits the utterance content “Temperature is higher than reference temperature but turn on boiler” of the user C stored in the communication history 123 to all the user terminals 500 within the communication group including the user terminal 500 of the user C for display synchronization (S1012).

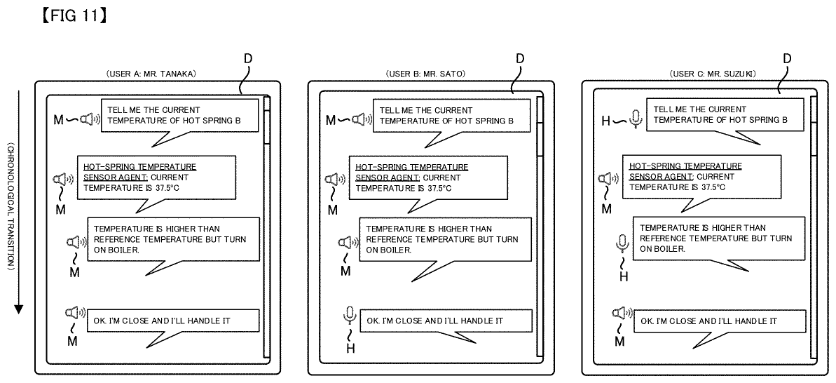

FIG. 11 shows examples of screens displayed on the user terminals 500 according to Embodiment 2. As shown in FIG. 11, each user terminal 500 chronologically displays, in the display field D, the utterance content of the user of that terminal 500 and the utterance contents of the other users as well as the utterance content representing questioning and calling to the agent apparatus 300 and the utterance content of the agent apparatus 300 in response to the questioning and calling, thereby sharing the communication history 123 accumulated in the management apparatus 100 as log information.

In Embodiment 2, the agent apparatus 300 understands questioning and calling from the user, and for each questioning or calling, produces and provides the agent utterance text based on the detection information from the state detection device. The agent apparatus 300 can act as a pseudo user within the communication group to provide an environment of communication closer to conversations between users for information transmission.

Examples of the facility include buildings in security service business and berths (places for dispatch and arrival) in logistics business, in addition to the one described above. Various state detection devices can be used appropriately for different scenes in which the communication system according to the present invention is utilized, in addition to the temperature sensor.

A camera is an example of the state detection device. Based on images taken by the camera, the movements of people and the congestion degree can be analyzed and determined, and when the analysis result shows “many people moved to bath” or “people waiting in line at the front,” the agent apparatus 300 can transmit an agent utterance text associated with the analysis result to the management apparatus 100 to notify the user terminal 500 with a synthesized voice and a text display. In another example relating to congestion, the congestion degree in a parking area can be analyzed and determined to notify the user terminal 500 with a synthesized voice and a text display of “Parking area will be full soon,” or “Prepare for second parking area.”

The agent apparatus 300 can also have a function of extracting a specified person from images taken by the camera. In this case, for example, the agent apparatus 300 can match a previously registered image including a specified person with images taken by the camera serving as the state detection device, and based on the information about the place where the camera is installed, provide an analysis result showing “a certain person arrives at a certain place.” With such an analysis result as a trigger, the agent apparatus 300 can output an agent utterance text “Mr. XX is at YY” and notify the user terminals 500 with the synthesized voice of the agent utterance text via the management apparatus 100.

In another example, a weight sensor can be used as the state detection device. For example, in cooperation with a weight sensor used for an elevator, the agent apparatus 300 can output an agent utterance text “Elevator is crowded” in response to sensing of overload fiver times or more within ten minutes, and notify the user terminals 500 (the users) with the synthesized voice of the agent utterance text via the management apparatus 100. Then, any of the users can to move to traffic control as required.

A GPS apparatus (position information detection device) can also be used as the state detection device. For example, the GPS apparatus can be attached to a cart pulled by humans, and the agent apparatus 300 can be configured to acquire position information of the cart from the GPS apparatus. The agent apparatus 300 can match a preset route or a no-entry zone with the current position of the cart and detect displacement from the route within a predetermined range or entry into the no-entry zone. Upon detection thereof, the agent apparatus 300 can output an agent utterance text “Are you sure the route is correct?” or “You are in a no-entry zone” and notify user terminals 500 (users) with the synthesized voice of the agent utterance text via the management apparatus 100. The entry into the no-entry zone may be made not only by the users of the user terminal 500 but also by facility users. In this a case, upon reception of the notification, any of the users of the user terminals 500 can go to the no-entry zone and guide such a facility user as appropriate.

The communication management apparatus 100 can be configured to have the functions of the agent apparatus 300. More specifically, the functions of the agent apparatus 300 shown in FIG. 2 or FIG. 9 are provided as an agent section within the communication management apparatus 100, and the detection information from the state detection device is transmitted to the communication management apparatus 100. The state detection device may internally include a data communication function, or may be connected to a separate data communication device such that detection information can be transmitted to the communication management apparatus 100 via the data communication device. The agent section of the communication management apparatus 100 can receive the detection information output from the state detection device provided for the monitoring target and produce an agent utterance text based on the detection information, thereby operating as a member of the communication group, similarly to Embodiments 1 and 2.

### Embodiment 3

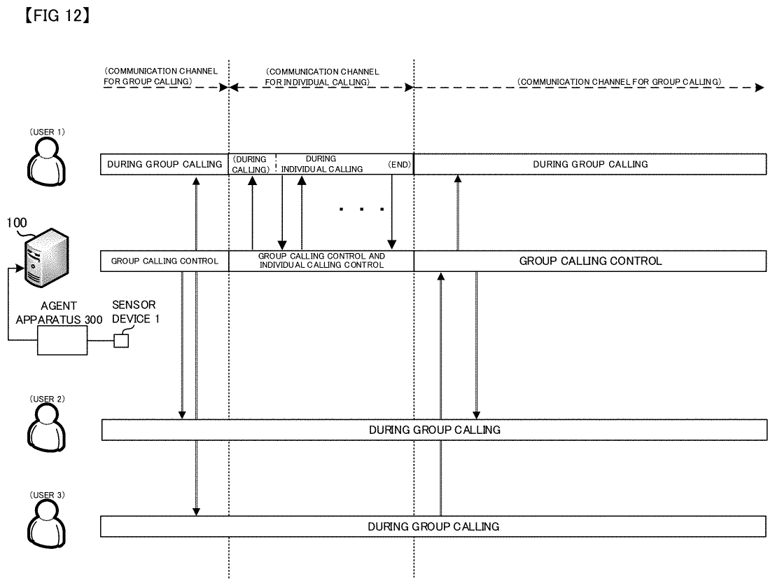

FIGS. 12 to 15 are diagrams for illustrating Embodiment 3. It should be noted that the same elements as those in Embodiment 1 are designated with the same reference numerals and their description is omitted.

The communication management apparatus 100 according to Embodiment 3 has an individual calling function in addition to the group calling function described above. FIG. 12 is a diagram for illustrating an example of interrupt processing to enter an individual calling mode during a group calling mode in Embodiment 3. As shown in FIG. 12, the agent apparatus 300 transmits an agent utterance text, and the synthesized voice based on the agent utterance text is transmitted only to a particular one of users within a communication group during group calling.

As described above, the agent apparatus 300 is registered as a member (agent) of the communication group. Embodiment 3 provides an individual calling function between the agent and a particular user via the management apparatus 100.

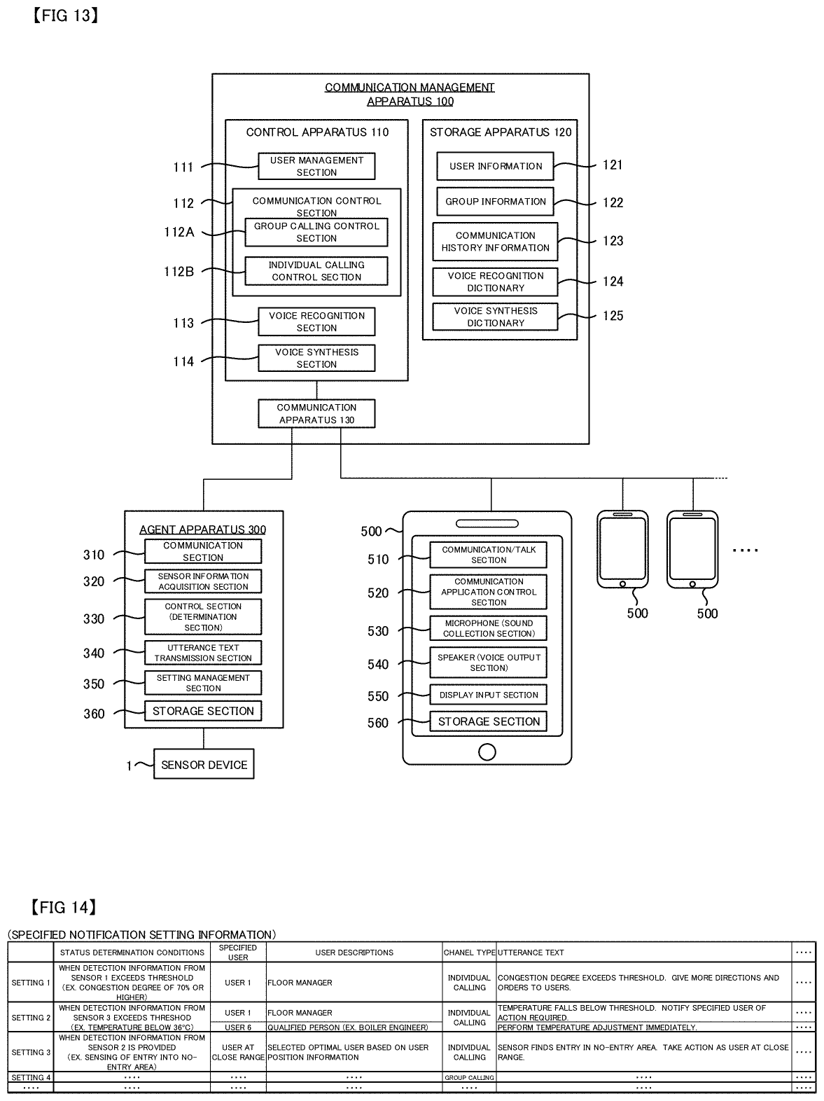

FIG. 13 is a block diagram showing the configurations of the management apparatus (communication management apparatus) 100, the agent apparatus 300, and the user terminal 500 according to Embodiment 3. As shown in FIG. 13, the first control section and the second control section described above in Embodiment 1 and Embodiment 2 are shown as a group calling control section 112A. The communication control section 112 includes the group calling control section 112A and an individual calling control section 112B.

The management apparatus 100 produces and stores a list of group members including a plurality of users registered in the communication group. The individual calling control section 112B specifies, in response to an individual calling request transmitted from the agent apparatus 300, the requested user from the list of group members.

The individual calling control section 112B provides the individual calling function of transmitting utterance voice data only to a particular user selected from the users within the communication group in which broadcast is performed during group calling. The individual calling control section 112B performs calling processing of originating a call to a specified user in order for the agent apparatus 300 to perform one-to-one calling with the particular user via the management apparatus 100 during the group calling mode. The calling processing is interrupt processing to the maintained group calling mode. When the specified user responds to the calling processing, call connection processing (processing of establishing an individual calling communication channel) is performed. This is followed by processing of delivering the utterance voice data only to the particular user from the agent over the established calling channel. The whole processing is performed as individual calling interrupt processing for performing calling with the particular user separately from the other users within the communication group while maintaining the group calling within the communication group.

The individual calling function according to Embodiment 3 can be used between two users other than the agent. The management apparatus 100 can deliver the list of group members including the users registered in the communication group to the user terminals 500 in advance. Upon selection of a user to be called in individual calling from the list of group members, the user terminal 500 can transmit an individual calling request including the selected user to the management apparatus 100. The individual calling control section 112B can perform calling processing for the selected user and establish an individual calling communication channel based on the response action of the called user.

The individual calling control section 112B can receive an individual calling request and open an individual calling channel to a specified or selected user to provide a one-to-one calling function at times other than the group calling mode.

After the individual calling, processing of automatic return to the group calling mode maintained in the communication group can be performed. The automatic return processing is performed by the communication control section 112. When the user terminal 500 is operated to end the individual calling mode, the communication control section 112 performs processing of disconnecting the established individual calling channel and automatic returning to the communication channel of the ongoing group calling mode. Alternatively, automatic return to the group calling mode may be performed when the individual calling control section 112B performs processing of disconnecting the individual calling communication channel.

The calling time during the individual calling mode (call start time, duration after call response, and call end time) is accumulated as an individual calling mode execution history in the management apparatus 100 together with a history of parties involved in individual calling. Similarly to the group calling mode, the utterance voice data during the individual calling can be converted into text form through voice recognition processing and stored in the communication history information 123 or stored individually in association with the time course in the communication history information 123. The utterance voice data during the individual calling mode can also be stored in the storage apparatus 120.

As described above, the management apparatus 100 (communication apparatus 130) according to Embodiment 3 performs, based on the group calling function, broadcast communication control of simultaneously transmitting utterance voice data and utterance content text information (text information produced through voice recognition processing on the utterance voice data) from one user to the user terminals 500. The management apparatus 100 also performs, based on the individual calling function, individual delivery communication control of transmitting utterance voice data to a particular user (user for individual calling).

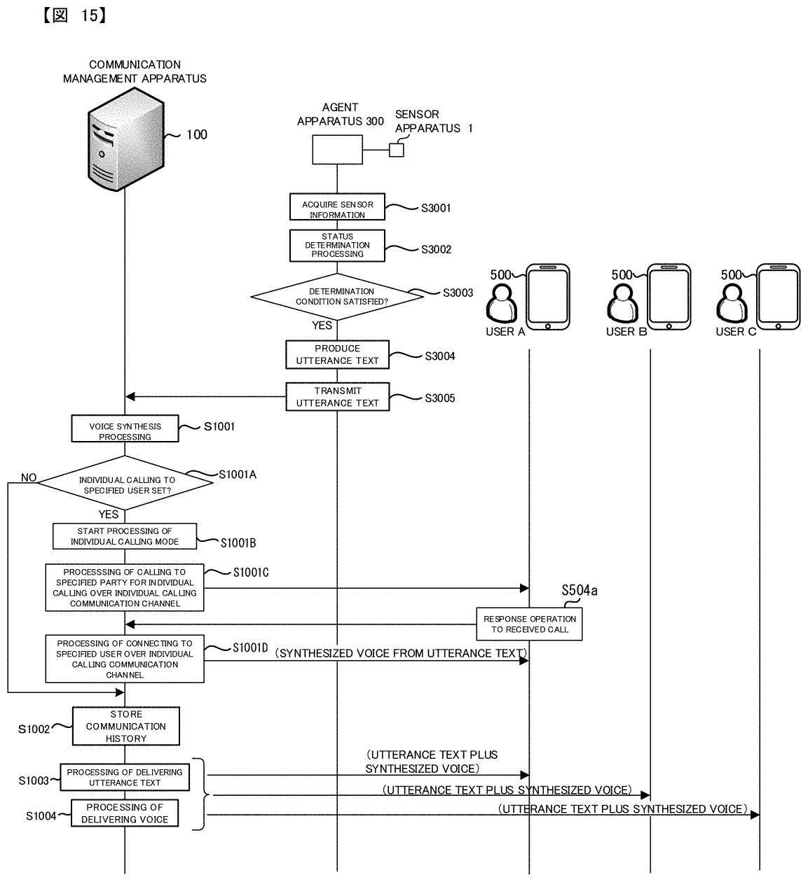

The agent apparatus 300 can previously store specified notification setting information shown in FIG. 14. As shown in FIG. 14, status determination conditions are set, and a specified user to be contacted through individual calling is determined for each of the conditions. The contents to be transmitted (agent utterance texts) are previously set.

The specified notification setting information shown in FIG. 14 is provided by adding users to be contacted (specified users and user descriptions) and types of channel indicating a way to contact (individual calling or group calling) to the setting management information shown in FIG. 5 in Embodiments 1 and 2. The determination conditions in FIG. 5 correspond to the status determination conditions in FIG. 14.

FIG. 15 is a diagram showing a flow of processing of a third case performed in the communication system according to Embodiment 3.

The control section (determination section) 330 of the agent apparatus 300 receives detection information output from the sensor device (state detection device) 1 provided for the monitoring target (S3001) and matches the detection information with the “status determination conditions” in the specified notification setting information (S3002). It is determined whether or not the received detection information satisfies any of the status determination conditions (S3003). When it is determined that any of the status determination conditions is satisfied (YES at S3003), the agent apparatus 300 extracts a preset utterance text associated with that condition (S3004) and transmits a contact request including information of the utterance text, a user to be contacted and a channel type associated with the condition to the management apparatus 100 (S3005).

When the management apparatus 100 receives the contact request from the agent apparatus 300, the voice synthesis section 114 produces synthesized voice data of the received agent utterance text (S1001).

Next, the communication control section 112 refers to the channel type and the specified user to be contacted included in the received contact request to check whether or not individual calling to the specified user is set (S1001A). When the channel type is “group calling,” the control proceeds to step S1002 to perform contact processing in the group calling mode instead of the individual calling mode (S1003, S1004). The utterance text and other data are accumulated chronologically in the communication history 123 (S1002).

When it is determined at step S1001A that individual calling to the specified user is set (YES at S1001A), the individual calling control section 112B performs (interrupt) processing on the specified user included in the contact request for entering an individual calling mode during the current group calling mode (S1001B). Specifically, the individual calling control section 112B performs processing of calling to the specified user over an individual calling communication channel (1001C). Upon called, the specified user performs response operation to the received call (S504a). Once the specified user performs the operation to respond to the received call, the management apparatus 100 performs processing of establishing an individual calling connection between the management apparatus 100 and the specified user over the individual calling communication channel (S1001D). The individual calling control section 112B delivers the synthesized voice data of the agent utterance text to the user terminal 500 of the specified user through the individual calling connection. As described above, the contact is achieved between the agent and the specified user over the individual calling connection.

The specified user after transition to the individual calling mode is treated in the same manner as “on hold” from the perspective of the calling channel of the group calling. After the end of the individual calling, the specified user can automatically return to the communication channel of the group calling. The communication control section 112 also stores a history of contacts to the specified user during the individual calling mode in the communication history 123 (S1002).

Two or more parties may be selected by the agent for individual calling. In this case, individual calling channels to those specified users can be separately established, and synthesized voice data based on an agent utterance text can be delivered to them over those channels. In addition, different agent utterance texts may be set for different parties involved in individual calling. More specifically, as shown in the example of FIG. 14, an agent utterance text “Temperature falls below threshold. Notify specified user of action required” may be set for a floor manager, and an agent utterance text “Perform temperature adjustment immediately” may be set for a qualified person (for example, a boiler engineer). The floor manager and the qualified person are provided with synthesized voice data based on the different utterance texts under the same status determination condition.

The user to be contacted may not be a preset user. As shown in the example of FIG. 14, the position information of each user (user terminal) can be acquired, and when an event results from any of the status determination conditions being satisfied, one user or at least two users close to the site of the event can be determined as specified users who should deal with the event. In the example of FIG. 14, when entry into a no-entry area is sensed, a specified user is selected based on the user position information, and synthesized voice data of an utterance text “Sensor finds entry into no-entry area. Take action as user at close range” can be transmitted to the selected user.

As described above, the management apparatus 100 may be configured to have the functions of the agent apparatus 300. In a variation of Embodiment 3, the management apparatus 100 is configured to include an agent function section corresponding to the agent apparatus 300. The management apparatus 100 can receive detection information from the sensor device 1, perform the operations of steps S3002, S3003, and S3004, and achieve communication in the individual calling mode during group calling.

Various embodiments of the present invention have been described. The functions of the communication management apparatus 100 and the agent apparatus 300 can be implemented by a program. A computer program previously provided for implementing the functions can be stored on an auxiliary storage apparatus, the program stored on the auxiliary storage apparatus can be read by a control section such as a CPU to a main storage apparatus, and the program read to the main storage apparatus can be executed by the control section to perform the functions.

The program may be recorded on a computer readable recording medium and provided for the computer. Examples of the computer readable recording medium include optical disks such as a CD-ROM, phase-change optical disks such as a DVD-ROM, magneto-optical disks such as a Magnet-Optical (MO) disk and Mini Disk (MD), magnetic disks such as a floppy Disk® and removable hard disk, and memory cards such as a compact Flash®, smart media, SD memory card, and memory stick. Hardware apparatuses such as an integrated circuit (such as an IC chip) designed and configured specifically for the purpose of the present invention are included in the recording medium.

While various embodiments of the present invention have been described above, these embodiments are only illustrative and are not intended to limit the scope of the present invention. These novel embodiments can be implemented in other forms, and various omissions, substitutions, and modifications can be made thereto without departing from the spirit or scope of the present invention. These embodiment and their variations are encompassed within the spirit or scope of the present invention and within the invention set forth in the claims and the equivalents thereof.

### DESCRIPTION OF THE REFERENCE NUMERALS

100 COMMUNICATION MANAGEMENT APPARATUS
110 CONTROL APPARATUS
111 USER MANAGEMENT SECTION
112 COMMUNICATION CONTROL SECTION (FIRST CONTROL SECTION, SECOND CONTROL SECTION)
112A GROUP CALLING CONTROL SECTION (FIRST CONTROL SECTION, SECOND CONTROL SECTION)
112B INDIVIDUAL CALLING CONTROL SECTION
113 VOICE RECOGNITION SECTION
114 VOICE SYNTHESIS SECTION
120 STORAGE APPARATUS
121 USER INFORMATION
122 GROUP INFORMATION
123 COMMUNICATION HISTORY INFORMATION
124 VOICE RECOGNITION DICTIONARY
125 VOICE SYNTHESIS DICTIONARY
130 COMMUNICATION APPARATUS
300 AGENT APPARATUS
310 COMMUNICATION SECTION
320 SENSOR INFORMATION ACQUISITION SECTION
330 CONTROL SECTION (DETERMINATION SECTION)
330A CONTROL SECTION (INFORMATION PROVISION SECTION)
340 UTTERANCE TEXT TRANSMISSION SECTION
350 SETTING MANAGEMENT SECTION
360 STORAGE SECTION
370 TEXT RECEPTION SECTION
380 TEXT ANALYSIS SECTION
500 USER TERMINAL (MOBILE COMMUNICATION TERMINAL)
510 COMMUNICATION/TALK SECTION
520 COMMUNICATION APPLICATION CONTROL SECTION
530 MICROPHONE (SOUND COLLECTION SECTION)
540 SPEAKER (VOICE OUTPUT SECTION)
550 DISPLAY INPUT SECTION
560 STORAGE SECTION
D DISPLAY FIELD

1. A communication system in which a plurality of users carry their respective mobile communication terminals and a voice of an utterance of one of the users input to his mobile communication terminal is broadcast to the mobile communication terminals of the other users, comprising:
a communication management apparatus connected to each of the mobile communication terminals through wireless communication; and
an agent apparatus connected to the communication management apparatus and configured to receive detection information output from a state detection device provided a monitoring target,
wherein the communication management apparatus includes a communication control section having a first control section configured to broadcast utterance voice data received from one of the mobile communication terminals to the other mobile communication terminals and a second control section configured to chronologically accumulate a result of utterance voice recognition from voice recognition processing on the received utterance voice data as a user-to-user communication history and to control text delivery such that the communication history is displayed on the mobile communication terminals in synchronization,
the agent apparatus includes a utterance text transmission section configured to produce an agent utterance text based on the detection information and to transmit the produced agent utterance text to the communication management apparatus, and
the communication control section is configured to broadcast synthesized voice data of the agent utterance text produced through voice synthesis processing to the mobile communication terminals and to chronologically accumulate the received agent utterance text in the user-to-user communication history to control text delivery to the mobile communication terminals.

2. The communication system according to claim 1, wherein the communication management apparatus includes a user management section configured to set a communication group in which the mobile communication terminals are registered, the communication group being controlled by the first control section and the second control section, and
the user management section is configured to provide a function of registering the agent apparatus in the communication group.

3. The communication system according to claim 1,
wherein the agent apparatus includes a control section configured to determine based on a preset determination condition whether or not the detection information satisfies the determination condition, and
the utterance text transmission section is configured to produce the agent utterance text when it is determined that the detection information satisfies the determination condition.

4. The communication system according to claim 1, wherein the communication control section is configured to transmit the result of utterance voice recognition to the agent apparatus,
the agent apparatus includes:
a text reception section configured to receive the result of utterance voice recognition; and
an information provision section configured to determine whether or not the agent utterance text should be provided based on the result of utterance voice recognition, and
the utterance text transmission section is configured to produce the agent utterance text based on the result of the determination by the information provision section and to transmit the produced agent utterance text to the communication management apparatus.

5. The communication system according to claim 4, wherein the information provision section is configured to determine whether or not the result of utterance voice recognition includes a keyword relating to questioning about the state detection device or the detection information.

6. The communication system according to claim 1, wherein the communication control section includes:
an individual calling control section configured to transmit utterance voice data only to a particular user within the communication group, the broadcast being performed in the communication group, and
the individual calling control section is configured to perform individual calling control of transmitting synthesized voice data of the agent utterance text produced through voice synthesis processing to the particular user.

7. A communication method in which a plurality of users carry their respective mobile communication terminals and a voice of an utterance of one of the users input to his mobile communication terminal is broadcast to the mobile communication terminals of the other users, each of the mobile communication terminals being connected to a communication management apparatus through wireless communication, the communication management apparatus being connected to an agent apparatus configured to receive detection information output from a state detection device provided for a monitoring target, the method comprising:
a first step of broadcasting utterance voice data received from one of the mobile communication terminals to the other mobile communication terminals by the communication management apparatus;
a second step of chronologically accumulating a result of utterance voice recognition from voice recognition processing on the received utterance voice data as a user-to-user communication history and controlling text delivery such that the communication history is displayed on the mobile communication terminals in synchronization, by the communication management apparatus; and
a third step of producing an agent utterance text based on the detection information and transmitting the produced agent utterance text to the communication management apparatus by the agent apparatus,
wherein the first step includes broadcasting synthesized voice data of the agent utterance text produced through voice synthesis processing to the mobile communication terminals, and
the second step includes chronologically accumulating the received agent utterance text in the user-to-user communication history to control text delivery to the mobile communication terminals.

8. A non-transitory computer-readable medium storing a program comprising instructions executable by a management apparatus connected through wireless communication to mobile communication terminals carried by their respective users, the management apparatus being configured to broadcast a voice of an utterance of one of the users to the mobile communication terminals of the other users, wherein the instructions, when executed by the management apparatus, cause to management apparatus to provide:
a first function of broadcasting utterance voice data received from one of the mobile communication terminals to the other mobile communication terminals;
a second function of chronologically accumulating a result of utterance voice recognition from voice recognition processing on the received utterance voice data as a user-to-user communication history and controlling text delivery such that the communication history is displayed on the mobile communication terminals in synchronization; and
a third function of receiving an agent utterance text produced by an agent apparatus based on detection information and producing synthesized voice data of the agent utterance text, the detection information being output from a state detection device provided for a monitoring target and being input to the agent apparatus, the agent apparatus being connected to the management apparatus,
wherein the first function includes broadcasting the synthesized voice data of the agent utterance text to the mobile communication terminals, and
the second function includes chronologically accumulating the received agent utterance text in the user-to-user communication history to control text delivery to the mobile communication terminals.

9. A communication system in which a plurality of users carry their respective mobile communication terminals and a voice of an utterance of one of the users input to his mobile communication terminal is broadcast to the mobile communication terminals of the other users, comprising:
a communication control section having a first control section configured to broadcast utterance voice data received from one of the mobile communication terminals to the other mobile communication terminals and a second control section configured to chronologically accumulate a result of utterance voice recognition from voice recognition processing on the received utterance voice data as a user-to-user communication history and to control text delivery such that the communication history is displayed on the mobile communication terminals in synchronization; and
an agent section configured to receive detection information output from a state detection device provided for a monitoring target and to produce an agent utterance text based on the detection information,
wherein the communication control section is configured to broadcast synthesized voice data of the agent utterance text produced through voice synthesis processing to the mobile communication terminals and to chronologically accumulate the received agent utterance text in the user-to-user communication history to control text delivery to the mobile communication terminals.
